(19) United States
(12) Patent Application Publication
(10) Pub. No.: US 2025/0191147 A1
(43) Pub. Date: Jun. 12, 2025

(54) METHODS AND SYSTEMS FOR OPTICAL CHARACTER RECOGNITION AWARE SALIENCY MAP GUIDED TEXT DEBLURRING

(71) Applicant: SAMSUNG ELECTRONICS CO., LTD., Suwon-si (KR)

(72) Inventors: Arun D PRABHU, Bangalore, IN (US); Amit Satish UNDE, Bangalore (IN); Siddharth Deepak ROHEDA, Bangalore (IN); Harshit, Bangalore (IN); Shreyas PANDITH, Bangalore (IN); Rahul MISHRA, Bangalore (IN); Minkyu LEE, Suwon-si (IN); Heetak CHUNG, City Suwon-si (KR); Woojhon CHOI, Suwon-si (KR)

(73) Assignee: SAMSUNG ELECTRONICS CO., LTD., Suwon-si (KR)

(21) Appl. No.: 19/061,316

(22) Filed: Feb. 24, 2025

Related U.S. Application Data
(63) Continuation of application No. PCT/KR2024/016538, filed on Oct. 28, 2024.

(30) Foreign Application Priority Data
Oct. 27, 2023 (IN) 202341073384
Oct. 23, 2024 (IN) 202341073384

(51) Int. Cl. G06T 5/73; G06T 3/40; G06T 7/00; G06T 7/12; G06V 30/148

(52) U.S. Cl. CPC G06T 5/73; G06T 3/40; G06T 7/0002; G06T 7/12; G06V 30/148; G06T 2207/30168

(57) ABSTRACT

A method for correcting a blur in media, may include: receiving an input image indicating a degraded document comprising text regions and non-text regions; generating a blur localization map from the input image to detect a presence of a plurality of blur regions in the text regions and the non-text regions; estimating a degree of blur in the text regions of the plurality of blur regions by generating a text blur estimation map, to deblur the text regions based on a corresponding level of degradations; and generating a blur attention map by fusing the blur localization map and the text blur estimation map to output a location and a strength of the blur in the text regions.

### CROSS-REFERENCE TO RELATED APPLICATIONS

This application is a continuation application of International Application No. PCT/KR2024/016538 designating the United States, filed on Oct. 28, 2024, in the Korean Intellectual Property Receiving Office and claiming priority to Indian Provisional Patent Application No. 202341073384, filed on Oct. 27, 2023, in the Indian Patent Office, and Indian Patent Application number 202341073384, filed on Oct. 23, 2024, in the Indian Patent Office, the disclosures of which are incorporated by reference herein in their entireties.

### BACKGROUND

### 1. Field

The present disclosure relates to an optical character recognition-based text deblurring, and more particularly, to a method and system for optical character recognition aware saliency map guided text deblurring.

### 2. Description of Related Art

In recent years, mobile devices have become increasingly popular for capturing various types of text documents such as receipts, books, or handwritten notes. However, quality of images is often compromised due to blur in the images. Document scanning has gained widespread attention in the consumer market of smartphones. In the recent past, leading smartphone vendors have made exceptional progress in improving the readability of scanned documents. However, one of the most common artifacts seen in scanned documents is text blurring, due to which text de-blur becomes a very critical enhancement. The text blurring in scanned documents may be caused due to one of two reasons. One is camera in motion and another is auto-focus failure. Therefore, text readability is important when performing de-blur to resolve this artifact. Also, the amount of blur varies in a document. For instance, the blur may be a global motion blur, a defocus blur, a varying blur and a localized blur. In the global motion blur, characters or letters in the document look in motion. In the defocus blur the characters are not sharp due to integrating light. In the varying blur, the document is not uniformly blurred. In the localized blur, the characters in words are not arranged in a specific manner to produce a meaningful text. This variation leads to non-uniform deblurring of images and deteriorates the text readability and overall aesthetics of the document.

Generally, the global motion blur is due to camera shake during capture and by relative motion between the camera and objects. The defocus blur, the localized blur, and the spatially varying blur occur owing to a wide aperture, shallow depth-of-field, and incorrect focus settings. Blur in text images deteriorates the quality of the images significantly and leads to decreased legibility. Hence, text deblurring is crucial for enhancing the readability of the image. Text deblurring has a significant impact on the accuracy and effectiveness of other downstream applications such as optical character recognition (OCR).

Currently, the deblurring is done using a deblur engine which restores the character independently without taking the complete word characteristics into account in a severe blur image. Such a process, may not produce meaningful restored text. In addition, text distortion also happens through uneven thinning, thickening, or over-sharpness. This makes the deblur engine unworthy. Alternatively, there are different methods employed for text deblurring, as mentioned below in conjunction with FIG. 1.

FIG. 1 illustrates different methods for text deblurring, in accordance with related art.

A first method is a kernel estimation and deblurring method. In the first method, a blur kernel is estimated from a blurred image by a separately or jointly trained kernel-prediction network. The first method involves deconvolution with the estimated blur kernel to obtain the deblurred image. However, in the first method, real-world blurring scenarios are difficult to model via a single blur kernel. Although, the first method restores some regions in the blurred images, however, some blurred regions are left untouched during deblurring.

A second method is a frequency-based method. In the second method, images are first converted to some frequency domain such as wavelet, Fourier, etc. Further, low-frequency regions are classified as blur and are taken into account to learn better deblurring. The second method cannot differentiate smooth regions from blurred regions, since both will fall in a low-frequency band. Also, the second method fails to precisely localize the blur region and causes uneven deblurring. A third method is a learning-based method. The third method is an end-to-end mapping from blur to sharp image is learned using a neural network. The third method does not exploit the text and language-related information. This leads to over-sharpness or text thinning/thickening issues.

Moreover, deep learning methods have been utilized for the text deblurring and these deep learning methods have achieved considerable success in deblurring natural images. However, the deep learning methods are not suitable for text images due to the small size and high contrast of text, the presence of sharp edges, and fine details. There are certain issues with current approaches to deburring text in documents or images. For instance, scanned blurry documents are difficult to read. Further, developing a blur-type-agnostic deblur engine is extremely challenging due to the complex characteristics of different kinds of blur and their strength. Also, a lexically-agnostic deblur engine without taking text context into account leads to meaningless text restoration. Therefore, a specific deblurring solution that can handle text is necessary.

Therefore, in view of the above-mentioned problems, it is advantageous to provide an improved system and method that can overcome the above-mentioned problems of non-uniform deblurring and meaningless text restoration and limitations associated with blurred images.

### SUMMARY

According to one or more example embodiments, a method for correcting a blur in media, may include: receiving an input image indicating a degraded document comprising text regions and non-text regions; generating a blur localization map from the input image to detect a presence of a plurality of blur regions in the text regions and the non-text regions; estimating a degree of blur in the text regions of the plurality of blur regions by generating a text blur estimation map, to deblur the text regions based on a corresponding level of degradations; generating a blur attention map by fusing the blur localization map and the text blur estimation map to output a location and a strength of the blur in the text regions; generating a blur aware text map based on correcting text in the text regions; generating a text restoration map based on passing the blur aware text map through a series of convolution layers to restore the text in the text regions of the plurality of blur regions; performing text deblurring on the plurality of blur regions based on the blur attention map and the text restoration map; generating a deblurred image based on the deblurred blur regions; and outputting the generated deblurred image.

According to one or more example embodiments, a system for correcting a blur in media, may include: at least one processor; and memory storing instructions that, when executed by the at least one processor cause the at least one processor to: receive an input image indicating a degraded document comprising text and non-text regions; generate a blur localization map from the input image to detect a presence of a plurality of blur regions in the text and non-text regions; estimate a degree of blur in text regions of the plurality of blur regions by generating a text blur estimation map, to deblur the text regions based on a corresponding level of degradations; generate a blur attention map by fusing the blur localization map and the text blur estimation map to output a location and a strength of the blur in the text regions; generate a blur aware text map based on correcting text in the text regions; generate a text restoration map based on passing the blur aware text map through a series of convolution layers to restore the text in the text regions of the plurality of blur regions; perform text deblurring on the plurality of blur regions based on the blur attention map and the text restoration map; generate a deblurred image based on the deblurred blur regions; and output the generated deblurred image.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates different methods for text deblurring, in accordance with related art;

FIG. 2 illustrates a block diagram of a system for correcting a blur in a media, in accordance with one or more embodiments of the present disclosure;

FIG. 3 illustrates a block diagram depicting a user equipment (UE), in accordance with one or more embodiments of the present disclosure;

FIG. 4 illustrates a sequence flow depicting an operation of an edge-based blur localizer of the system, in accordance with one or more embodiments of the present disclosure;

FIG. 5 illustrates a sequence flow depicting an operation of a lexically-aware text blur estimator of the system, in accordance with one or more embodiments of the present disclosure;

FIG. 6 illustrates a sequence flow depicting an operation of a blur attention map extractor of the system, in accordance with one or more embodiments of the present disclosure;

FIG. 7 illustrates a sequence flow depicting an operation of a blur-aware localized language corrector of the system, in accordance with one or more embodiments of the present disclosure;

FIG. 8 illustrates a sequence flow depicting an operation of a blur-aware text restoration map extractor of the system, in accordance with one or more embodiments of the present disclosure;

FIG. 9A illustrates a sequence flow depicting operations of a blur attention and text restoration map guided text deblurring of the system, in accordance with one or more embodiments of the present disclosure;

FIG. 9B illustrates a sequence flow depicting operations of a blur attention and text restoration map guided text deblurring of the system, in accordance with one or more embodiments of the present disclosure;

FIG. 9C illustrates a sequence flow depicting operations of a blur attention and text restoration map guided text deblurring of the system, in accordance with one or more embodiments of the present disclosure;

FIG. 9D illustrates a sequence flow depicting operations of a blur attention and text restoration map guided text deblurring of the system, in accordance with one or more embodiments of the present disclosure;

FIG. 9E illustrates a sequence flow depicting operations of a blur attention and text restoration map guided text deblurring of the system, in accordance with one or more embodiments of the present disclosure;

FIG. 10 illustrates a flowchart depicting a method for correcting the blur in the media, in accordance with one or more embodiments of the present disclosure;

FIG. 11A illustrates an example scenario of deblurring different media, in accordance with one or more embodiments of the present disclosure;

FIG. 11B illustrates an example scenario of deblurring different media, in accordance with one or more embodiments of the present disclosure;

FIG. 11C illustrates an example scenario of deblurring different media, in accordance with one or more embodiments of the present disclosure;

FIG. 11D illustrates an example scenario of deblurring different media, in accordance with one or more embodiments of the present disclosure;

FIG. 12 illustrates another example scenario of text deblurring in low to mid-tier imaging devices, in accordance with one or more embodiments of the present disclosure;

FIG. 13 illustrates another example scenario depicting optical character recognition (OCR) predictions and associated down-stream tasks, in accordance with one or more embodiments of the present disclosure; and

FIG. 14 illustrates another example scenario depicting number plate recognition in fast moving vehicles, in accordance with one or more embodiments of the present disclosure.

Further, skilled artisans will appreciate those elements in the drawings are illustrated for simplicity and may not have necessarily been drawn to scale. For example, the flow charts illustrate the method in terms of the most prominent steps involved to help and improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

It should be understood at the outset that although illustrative implementations of the embodiments of the present disclosure are illustrated below, the disclosure may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some”, “one or more embodiment”, “one or more example embodiments”, as used herein is defined as “one, or more than one, or all.” Accordingly, the terms “one,” “more than one,” “more than one, but not all” or “all” would all fall under the definition of “some.” The term “some embodiments” may refer to one embodiment, several embodiments, or to all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises”, “has”, “have”, and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features”, “one or more elements”, “at least one feature” or “at least one element.” Furthermore, the use of the terms “one or more” or “at least one” feature or element does not preclude there being none of that feature or element unless otherwise specified by limiting language such as “there needs to be one or more . . . ” or “one or more element is required.”

The terms “A or B,” “at least one of A or/and B,” or “one or more of A or/and B” used in the various embodiments of the present disclosure includes any and all combinations of words enumerated with it. For example, “A or B,” “at least one of A and B,” or “at least one of A or B” means (1) including at least one A, (2) including at least one B, or (3) including both at least one A and at least one B.

Although the terms such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

The expression “configured to (or set to)” used in various embodiments of the present disclosure may be replaced with “suitable for,” “having the capacity to,” “designed to,” “adapted to,” “made to,” or “capable of” according to the situation. The term “configured to (set to)” does not necessarily mean “specifically designed to” as hardware. Instead, the expression “apparatus configured to . . . ” may mean that the apparatus is “capable of . . . ” along with other devices or parts in a certain situation. For example, “a processor configured to (set to) perform A, B, and C” may be a dedicated processor, for example, an embedded processor, for performing a corresponding operation, or a generic-purpose processor, for example, a Central Processing Unit (CPU) or an application processor (AP), capable of performing a corresponding operation by executing one or more software programs stored in a memory device.

A term “module” used in the present document may imply a unit including, for example, one of hardware, software, and firmware or a combination of two or more of them. The “module” may be interchangeably used with a term such as a unit, a logic, a logical block, a component, a circuit, and the like. The “module” may be a minimum unit of an integrally constituted component or may be a part thereof. The “module” may be a minimum unit for performing one or more functions or may be a part thereof. The “module” may be mechanically or electrically implemented. For example, the “module” of the present disclosure may include at least one of an Application-Specific Integrated Circuit (ASIC) chip, a Field-Programmable Gate Arrays (FPGAs), and a programmable-logic device, which are known or will be developed, and which perform certain operations.

Unless otherwise defined, all terms, and especially any technical and/or scientific terms, used herein may be taken to have the same meaning as commonly understood by one having ordinary skill in the art.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein.

As is traditional in the field, embodiments may be described and illustrated in terms of modules that carry out a described function or functions. These modules, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, third, etc. may be used herein to describe various elements, these elements should not be limited by these terms. These terms are generally only used to distinguish one element from another.

Embodiments of the present disclosure will be described below in detail with reference to the accompanying drawings.

The objective of the present disclosure is to a text-deblurring methodology that enhances the readability of documents. The present disclosure offers a method for lexically aware text deblurring to enhance blurred documents while taking into account the text information to improve readability. Further, the present disclosure offers a method for localizing blur in the documents for generating a saliency map to deblur documents with varying degrees of blur.

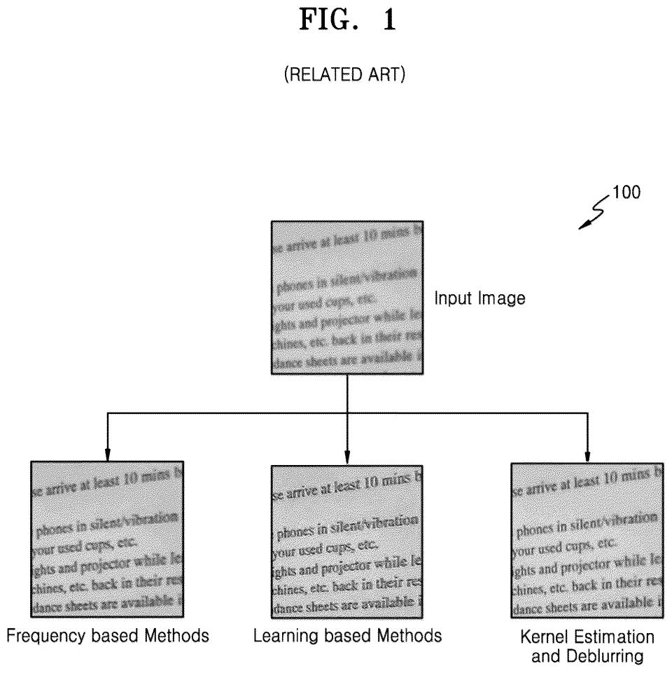

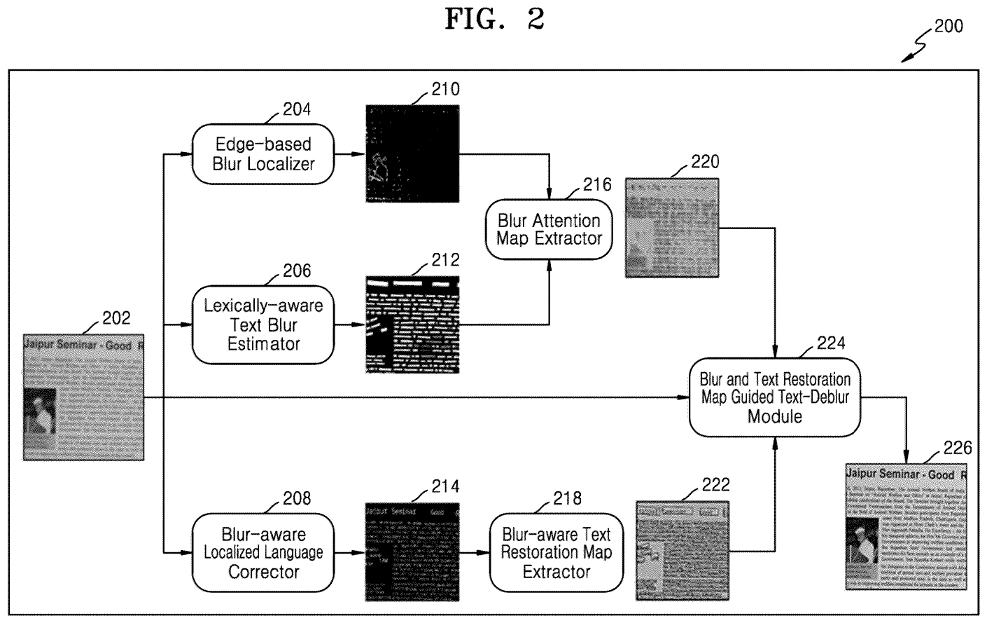

For the sake of clarity, the first digit of a reference numeral of each component of the present disclosure is indicative of the FIG. number, in which the corresponding component is shown. For example, reference numerals starting with digit “1” are shown at least in FIG. 1. Similarly, reference numerals starting with digit “2” are shown at least in FIG. 2.

FIG. 2 illustrates a block diagram of a system 200 for correcting a blur in a media, in accordance with one or more embodiments of the present disclosure.

The system 200 may be implemented over a user equipment (UE), such as, but not limited to, mobile phones, computer systems, and other imaging devices. In one or more embodiments, the system 200 may be implemented over a remote server. In one or more embodiments, a blurred image 202 or a blurred document may be deblurred by segregating text and non-text regions and restoring text regions along with language correction.

The system 200 may include an edge-based blur localizer 204 to extract a blur localization map 210, a lexically-aware text blur estimator 206 to generate a text blur strength estimation map 212, a blur-aware localized language corrector 208 to generate a blur-aware language corrected text map 214, a blur attention map extractor 216 to generate a blur localization and estimation map 220, a blur-aware text restoration map extractor 218 to generate a blur-aware text restoration feature map 222, and a blur and text restoration map guided text-deblur module 224 to generate a final output deblurred image 226.

For the sake of clarity, hereinafter, the edge-based blur localizer 204 may be referred to as a blur localizer 204, the lexically-aware text blur estimator 206 may be referred to as a blur estimator 206, the blur-aware localized language corrector 208 may be referred to as a language corrector 208, the blur localization map 210 may be referred to as a localization map 210, the text blur strength estimation map 212 may be referred to as an estimation map 212, the blur-aware language corrected text map 214 may be referred to as a corrected text map 214, the blur attention map extractor 216 may be referred to as an attention map extractor 216, the blur-aware text restoration map extractor 218 may be referred to as a restoration map extractor 218, the blur localization and estimation map 220 may be referred to as a localization and estimation map 220, the blur-aware text restoration feature map 222 may be referred to as a restoration map 222 and blur and text restoration map guided text-deblur module 224 may be referred to as a deblur module 224.

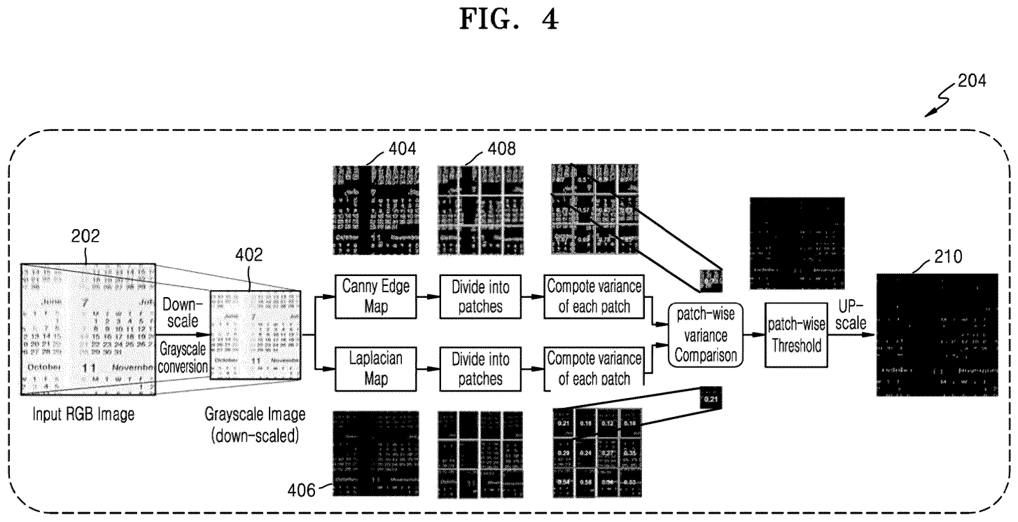

At first, the blurred image 202 may be fed to the blur localizer 204. In one or more embodiments, the blurred image 202 may be a blurred document or an image that may contain text regions and non-text regions and may be wholly or partially blurred. The blur localizer 204 may be configured to extract the localization map 210. The localization map 210 may be able to detect the presence of blur in both text and non-text regions of the blurred image 202. The blur localizer 204 is described in greater detail in conjunction with FIG. 4.

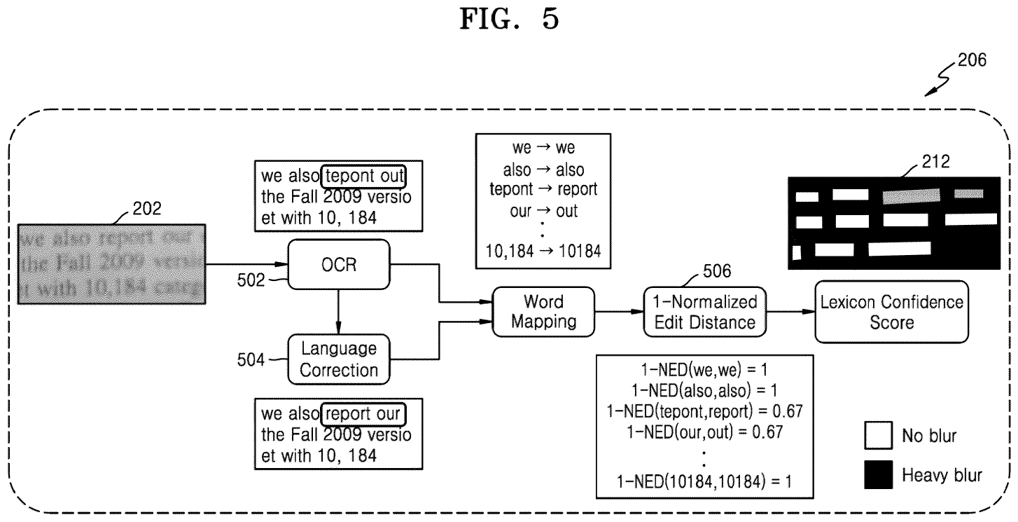

Further, the blur estimator 206 may be configured to generate the estimation map 212 from the blurred image 202. In one or more embodiments, the blur estimator 206 may signify confidence in optical character recognition (OCR) 502 predictions and quantify a degree of blur. The estimation map 212 may be utilized to estimate the degree of blur present only in the text region of the blurred image 202. The blur estimator 206 may deblur the text regions depending on the corresponding level of degradations and improve the readability. The blur estimator 206 is described in greater detail in conjunction with FIG. 5.

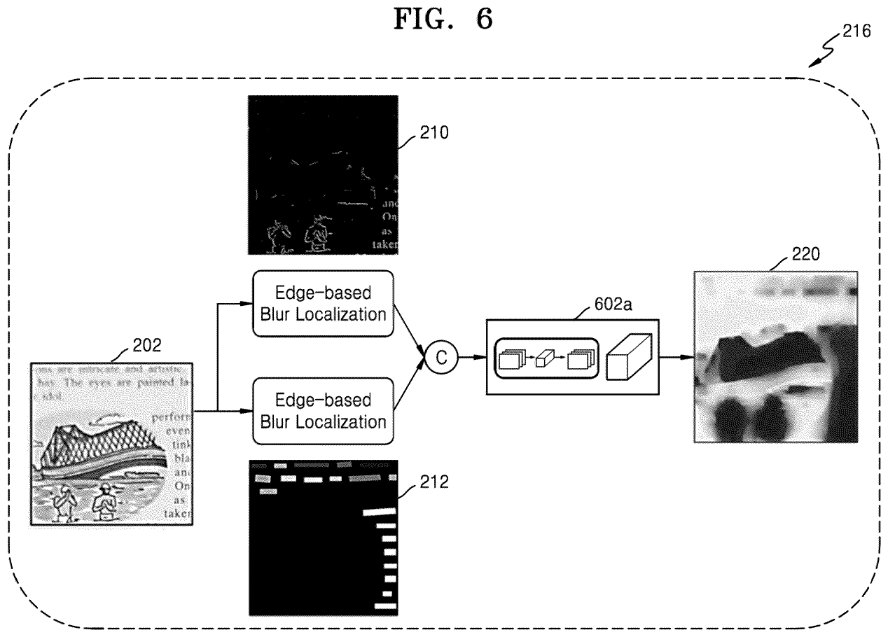

Further, the attention map extractor 216 may be configured to fuse the estimation map 212 from the blur estimator 206 and the localization map 210 from the blur localizer 204 to generate the localization and estimation map 220. The localization and estimation map 220 may provide both the location and strength of blur present in the blurred image 202. The attention map extractor 216 is described in greater detail in conjunction with FIG. 6.

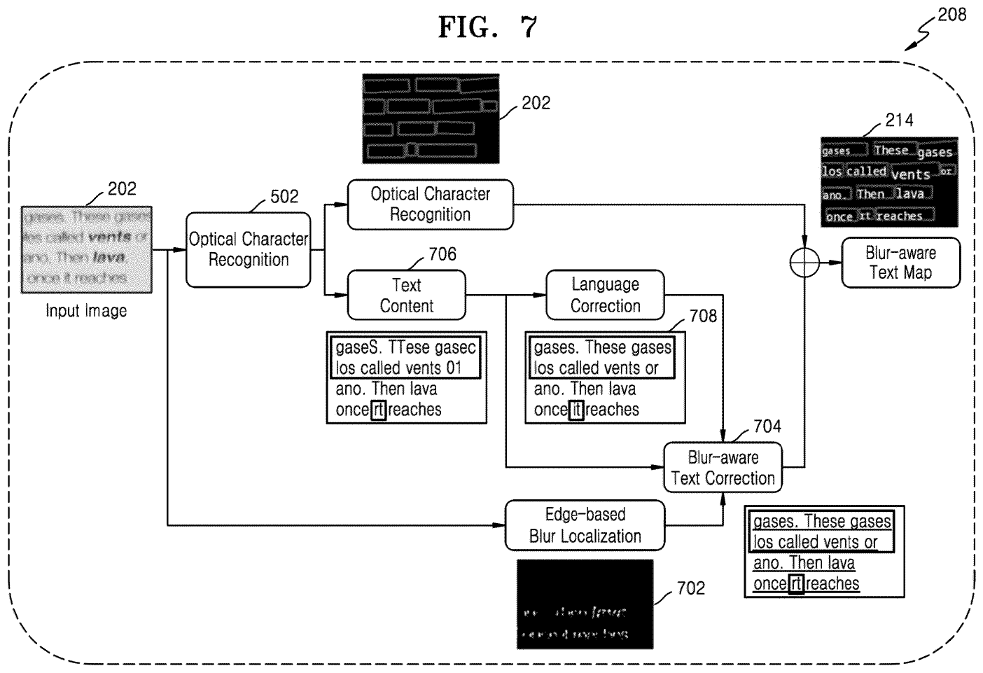

The language corrector 208 may be configured to generate the corrected text map 214 from the blurred image 202. The language corrector 208 may correct the text region of the blurred image 202 by restoring meaningful text only in the blurry regions. The language corrector 208 is described in greater detail in conjunction with FIG. 7. The corrected text map 214 generated by the language corrector 208 may be beneficial for restoring the meaningful text from the regions that have suffered with severe amount of blur.

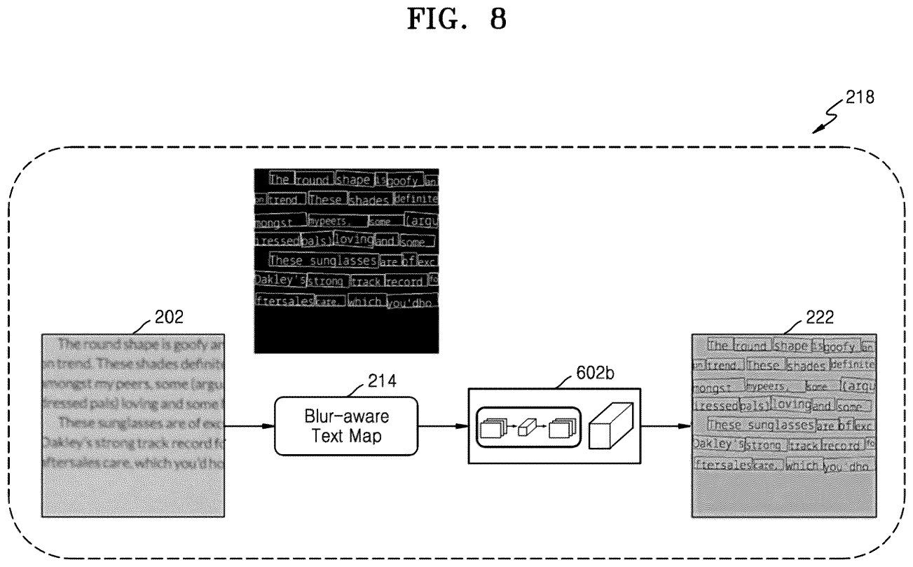

Further, the restoration map extractor 218 may be configured to generate the restoration map 222. The restoration map extractor 218 may restore the text in the regions that suffered with a severe amount of blur. The restoration map 222 may help the system 200 to restore text precisely in blurry regions without deteriorating the quality of the text in sharp regions. The restoration map extractor 218 is described in greater detail in conjunction with FIG. 8.

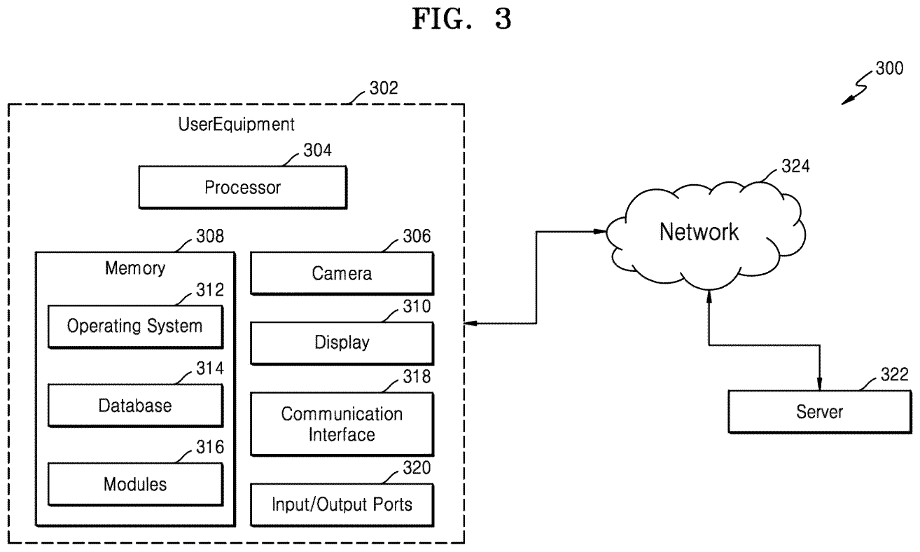

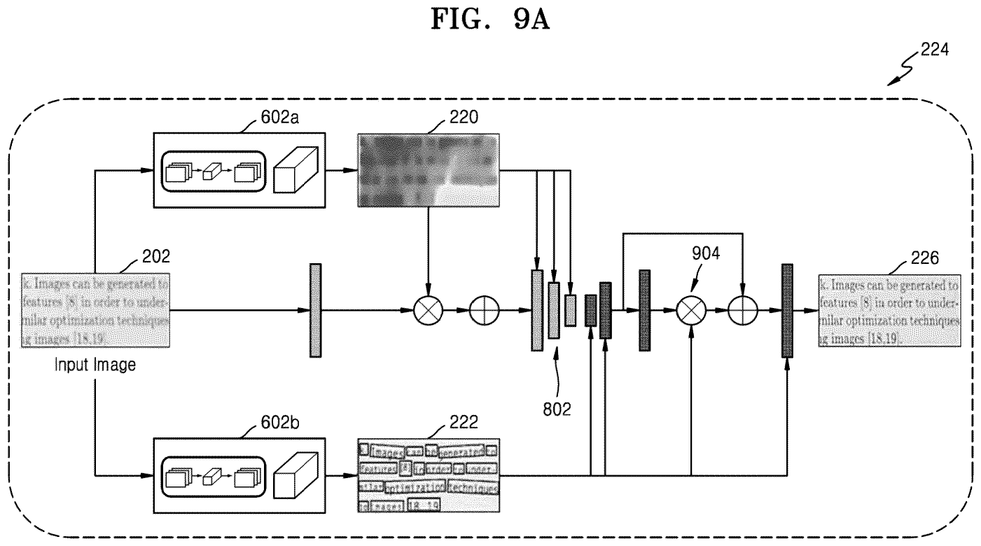

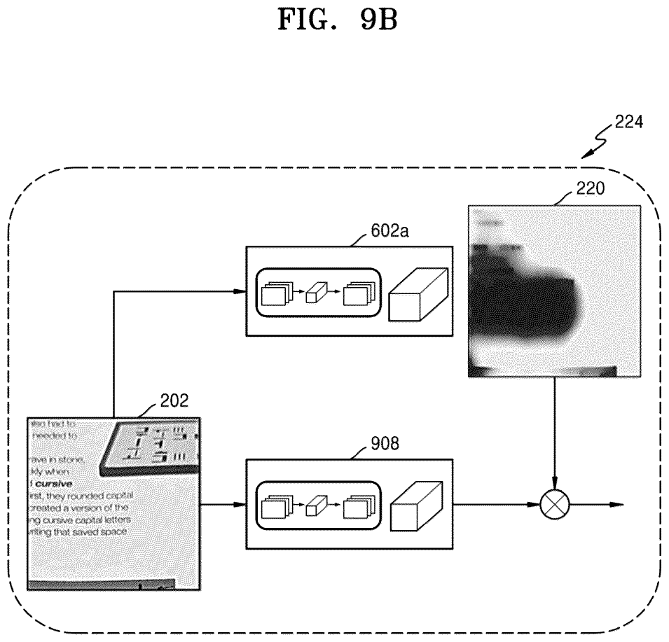

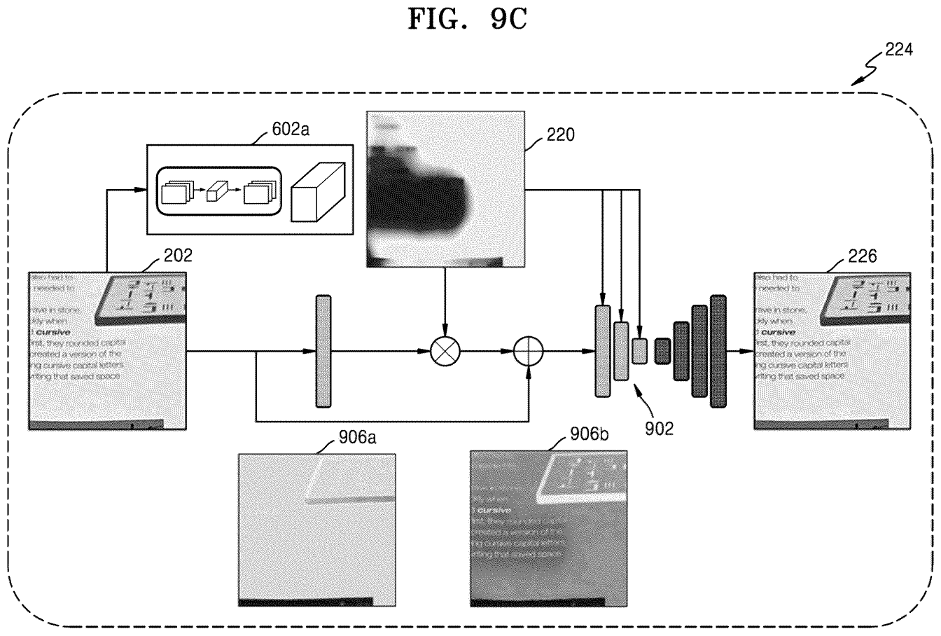

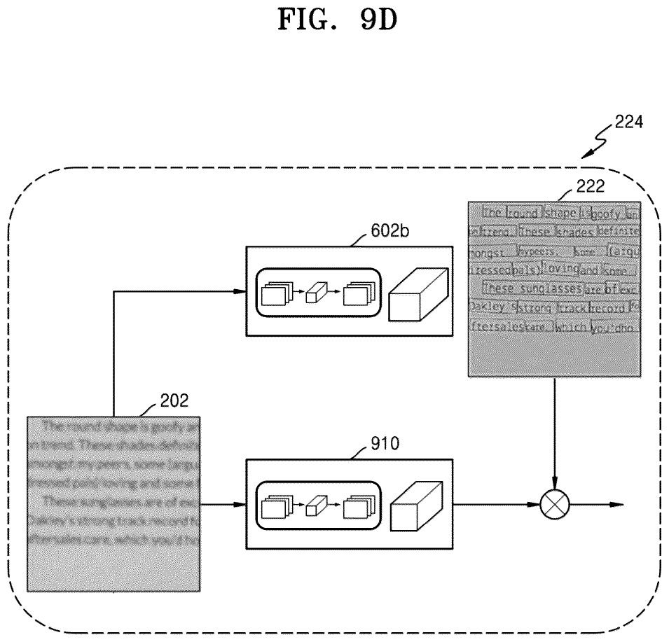

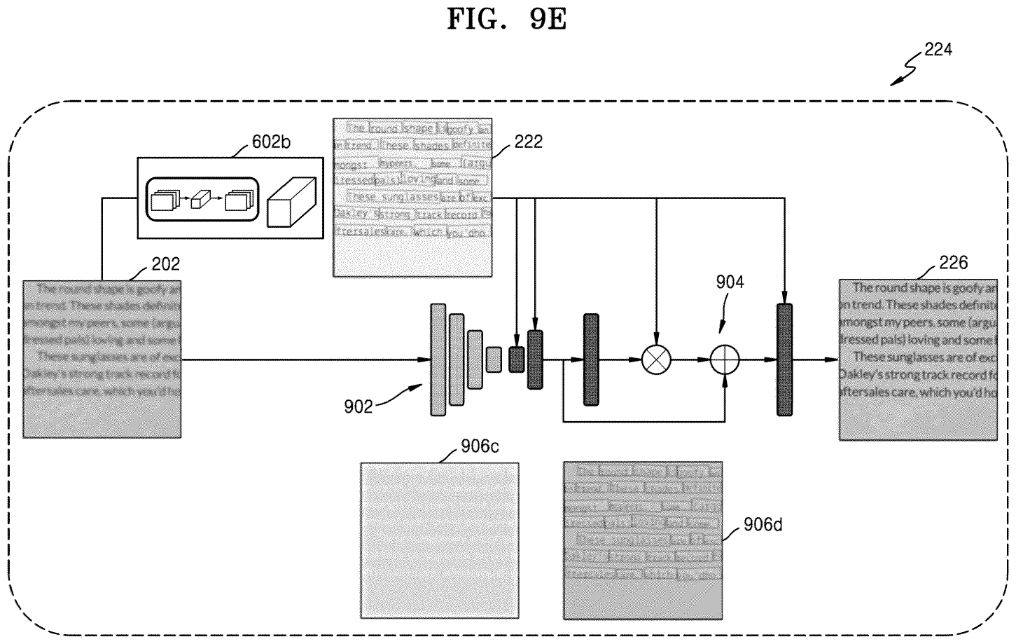

Further, the deblur module 224 may be configured to receive the localization and estimation map 220 from the attention map extractor 216 and the restoration map 222 from the restoration map extractor 218 to generate the final output deblurred image 226. The deblur module 224 may perform text deblurring with a guidance of the localization and estimation map 220 and the restoration map 222. The guidance through the localization and estimation map 220 may help the system 200 to suppress less useful features and only allow the propagation of more informative ones. The restoration map 222 may help the system 200 to restore the meaningful text from severely blurred regions. The deblur module 224 is described in greater detail in conjunction with FIGS. 9A-9E. In one or more embodiments, the system 200 may be implemented over the UE or through the remote server, as described in FIG. 3.

FIG. 3 illustrates an environment 300 depicting components of a user equipment (UE) 302, in accordance with one or more embodiments of the present disclosure.

The UE 302 may include a processor 304, a camera 306, a display 310, a memory 308, a communication interface 318, and input/output ports 320. The memory 308 may include an operating system 312, a database 314, and modules 316. The UE 302 may be communicatively coupled to a server 322 via a network 324.

The processor 304 may be implemented as one or more microprocessors, microcomputers, microcontrollers, digital signal processors, central processing units, state machines, logic circuitries, and/or any devices that manipulate signals based on operational instructions. Among other capabilities, the processor 304 may be configured to fetch and execute computer-readable instructions and data stored in the memory 308 and/or the modules 316. At this time, the processor 304 may be a general-purpose processor, such as a central processing unit (CPU), an application processor (AP), or the like, and an AI-dedicated processor such as a neural processing unit (NPU). The processor 304 may control the processing of input data in accordance with a predefined operating rule or artificial intelligence (AI) model stored in the non-volatile memory and the volatile memory, i.e., the memory 308. The predefined operating rule or artificial intelligence model is provided through training or learning. Further, the processor 304 may be operatively coupled to each of the memory, the I/O Interface. The processor 304 may be configured to process, execute, or perform a plurality of operations described herein.

The memory 308 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 308 is communicatively coupled with the processor to store processing instructions for completing the process. Further, the memory 308 may include the operating system 312 for performing one or more tasks of the system, as performed by an operating system 312 in a computing domain. The memory 308 is operable to store instructions executable by the processor 304.

As discussed, the UE 302 may include the processor 304, e.g., a central processing unit (CPU), a graphics processing unit (GPU), or both. The processor 304 may be a component in a variety of systems. For example, the processor 304 may be part of a standard personal computer or a workstation. The processor 304 may be one or more general processors, digital signal processors, application-specific integrated circuits, field-programmable gate arrays, servers, networks, digital circuits, analog circuits, combinations thereof, or other now known or later developed devices for analyzing and processing data. The processor 304 may implement a software program, such as code generated manually (i.e., programmed).

As mentioned above, the UE 302 may include the memory 308, such as a memory 308 that can communicate via a bus. The memory 308 may include but is not limited to, computer-readable storage media such as various types of volatile and non-volatile storage media, including, but not limited to, random access memory, read-only memory, programmable read-only memory, electrically programmable read-only memory, electrically erasable read-only memory, flash memory, magnetic tape or disk, optical media and the like. In one example, memory 308 includes a cache or random-access memory for the processor 304. In alternative examples, the memory 308 is separate from the processor 304, such as a cache memory of a processor, the system memory, or other memory. The memory 308 may be an external storage device or database for storing data. The memory 308 is operable to store instructions 206 executable by the processor 304. The functions, acts, or tasks illustrated in the FIGs. or described may be performed by the programmed processor 304 for executing the instructions 206 stored in the memory 308. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

As shown, the UE 302 may or may not further include the display 310, such as a liquid crystal display (LCD), an organic light-emitting diode (OLED), a flat panel display, a solid-state display, a cathode ray tube (CRT), a projector, a printer or other now known or later developed display device for outputting determined information. The display 310 may act as an interface for the user to see the functioning of the processor 304, or specifically as an interface with the software stored in the memory 308. In one or more embodiments, the camera 306 may be a camera of the UE 302 or of any other electronic device, like a smartphone, or security device, that is adapted to generate or scan images.

The disclosure contemplates a computer-readable medium that includes memory 308 having executable instructions responsive to a propagated signal so that a device connected to the network 324 can communicate voice, video, audio, images, or any other data over the network 324. Further, the instructions 208 may be transmitted or received over the network 324 via the communication interface 318 or the input/output ports 320. The communication interface 318 may be a part of the processor 304 or maybe a separate component. The communication interface 318 may be created in software or maybe a physical connection in hardware. The communication interface 318 may be configured to connect with the network 324, external media, the display 310, or any other components in UE 302, or combinations thereof. The connection with the network 324 may be a physical connection, such as a wired Ethernet connection or may be established wirelessly as discussed later. Likewise, the additional connections with other components of the UE 302 may be physical or may be established wirelessly.

The network 324 may include wired networks, wireless networks, Ethernet AVB networks, or combinations thereof. The wireless network may be a cellular telephone network, an 802.11, 802.16, 802.20, 802.1Q, or WiMax network. Further, the network 324 may be a public network, such as the Internet, a private network, such as an intranet, or combinations thereof, and may utilize a variety of networking protocols now available or later developed including, but not limited to, TCP/IP based networking protocols. The UE 302 may not be limited to operation with any particular standards and protocols. For example, standards for Internet and other packet-switched network transmissions (e.g., TCP/IP, UDP/IP, HTML, and HTTP) may be used.

The processor 304 may be configured to receive the blurred image 202 as an input image. The blurred image 202 may be a degraded document having the text and the non-text regions, as discussed earlier. Further, the processor 304 may be configured to generate the localization map 210 from the blurred image to detect the presence of a plurality of blur regions in the text and non-text regions.

In one or more embodiments, the processor 304, for generating the localization map 210 may further be configured to compress the blurred image 202 to a lower resolution and convert the lower resolution blurred image to a grayscale image 402, as illustrated in FIG. 4. Further, processor 304 may generate a canny edge map 404 and a Laplacian edge map 406 from the grayscale image 402 to extract structural information and detect edges of the grayscale image 402 in the presence of the plurality of blur regions. The canny edge map 404 refers to an edge detection operator that uses a multi-stage algorithm to detect a wide range of edges in the blurred image 202. The Laplacian edge map 406 refers to a two-dimensional (2D) isotropic measure of a 2^{nd} spatial derivative of the blurred image 202. For example, Laplacian of an image highlights regions of rapid intensity change. Further, in this embodiment, the processor 304 may be configured to detect a region of rapid intensity change based on the Laplacian edge map 406. Further, the processor 304 may be configured to divide the canny edge map 404 and the Laplacian edge map 406 into a plurality of small patches 408 for blur localization. In this embodiment, each of the plurality of small patches 408 indicates white pixels and black pixels. The white pixels indicate the presence of an edge. Further, in this embodiment, the processor 304 may be configured to calculate a variance of each of the plurality of small patches 408 of the canny edge map 404 and the Laplacian edge map 406. The variance indicates a proportion of the white pixels in comparison with the black pixels in each of the plurality of small patches 408. Further, the processor 304 may be configured to compare the variance of each of the plurality of small patches 408 of the canny edge map 404 with each of the plurality of small patches 408 of the Laplacian edge map 406, based on computing a ratio of a variance of each patch of the Laplacian edge map 406 and a corresponding patch of the canny edge map 404. The ratio of variance is directly proportional to a degree of sharpness. Further, in this embodiment, the processor 304 may be configured to generate the blur localization map based on performing thresholding on each patch of the plurality of small patches 408 of the canny edge map 404 and the Laplacian edge map 406.

Further, the processor 304 may be configured to estimate the degree of blur present in text regions of the plurality of blur regions by generating the estimation map 212, to deblur the text regions based on corresponding levels of degradations. In one or more embodiments, the processor 304, in order to estimate the degree of blur present in the text regions, may locate and extract the text present in the blurred image 202 by passing the blurred image 202 through the OCR 502. Further, the processor 304 may obtain corrected text by identifying and correcting spelling errors in the text present in the blurred image 202. In this embodiment, the processor 304 may map words in the text present in the blurred image 202 to words in the corrected text, through a normalized edit distance (NED) 506. The NED 506 indicates the confidence in prediction of the OCR 502 to estimate the degree of blur. The NED 506 may be the minimum for a given word when the OCR 502 prediction of the given word and the language-corrected output exactly match. The NED 506 may be the maximum when the OCR 502 prediction for the given word and the language-corrected output differ in every alphabet position. In this embodiment, the processor 304 may assign a lexicon confidence score based on the value of the NED 506 to generate the estimation map 212.

Further, the processor 304 may be configured to generate the localization and estimation map 220 (or referred to as a blur attention map) by fusing the localization map 210 and the estimation map 212 to output the location and strength of the blur present in the text regions. In one or more embodiments, the processor 304, in order to generate the localization and estimation map 220 may detect the presence of the plurality of blur regions in the text and non-text regions based on the localization map 210. Further, the processor 304 may estimate the degree of blur present in the text region based on the estimation map 212. Further, the processor 304 in this embodiment, may generate the localization and estimation map 220 by concatenating the localization map 210 and the estimation map 212 by passing through a series of convolutional layers and using a sigmoid activation function.

Further, the processor 304 may be configured to generate the corrected text map 214 based on correcting text in the text regions. In one or more embodiments, the processor 304, in order to, correct text in the text regions, may locate and extract the text present in the input image by passing the input image through the OCR 502. The processor 304 may construct bounding boxes of the words based on the location of the text, to differentiate between adjacent words in the plurality of blur regions. In this embodiment, the processor 304 may identify and correct spelling errors in the extracted text present in the blurred image 202 through a language correction model 504. The processor 304 may identify the plurality of blur regions in the blurred image 202 based on the localization map 210 and perform text correction by taking a convex combination of the text and the corrected text through the localization map 210. Further, in this embodiment, the processor 304 may generate the corrected text map 214 by combining localization map 210 and corrected text by the language corrector 208. The text correction is directly proportional to the localization map 210, text content, and the corrected text content.

Further, the processor 304 may be configured to generate the restoration map 222 based on passing the corrected text map 214 through a series of convolution layers to restore the text in the text regions of the plurality of blur regions. Further, the processor 304 may be configured to perform text deblurring on the plurality of blur regions based on the blur attention map and the restoration map 222. In one or more embodiments, the processor 304, in order to perform text deblurring, may extract task-specific features 906c-906d by passing the blurred image 202 through the series of convolutional layers. Further, the processor 304 may extract color and font-related information by passing the blurred image 202 through an encoder. The encoder will be described later in conjunction with FIGS. 9A-9E. The processor 304 may estimate the degree of blur present in the text region based on the estimation map 212. In this embodiment, the processor 304 may perform the text deblurring on the plurality of blur regions based on the restoration map 222.

In this embodiment, the processor 304 may restore the plurality of blur regions by determining task-specific features 906a-906b of the plurality of blur regions based on multiplying elementwise, the task-specific features 906a-906b with the localization and estimation map 220, without changing the quality of sharp regions. Further, the processor 304 may generate the restoration map 222 indicative of useful features and suppress less useful features by multiplying the blur attention map by the useful features of each encoder level. Further, the processor 304 may restore, by the restoration map 222, text precisely by correcting the text in the plurality of blur regions.

As discussed, the system 200 may be implemented over the UE 302. The system 200 will be described in detail in conjunction with FIGS. 4-14.

FIG. 4 illustrates a sequence flow depicting an operation of the blur localizer 204 of the system 200, in accordance with one or more embodiments of the present disclosure.

The blur localizer 204 may be configured to localize blur regions based on edge information. As described earlier, the high-resolution blurred image 202 may be fed as the input to the blur localizer 204 and the localization map 210 containing the white pixels indicating sharp edges may be generated as an output of the blur localizer 204.

In one or more embodiments, the blurred image 202 may also be referred to as a high-resolution input image which may be first down-scaled to a lower resolution to reduce the processing time of subsequent operations and then converted to the grayscale image 402. Further, the canny edge map 404 may be computed on the resultant down-scaled image. The canny edge map 404 may extract the structural information and accurately detect edges even in the presence of blur. Further, the Laplacian edge map 406 of the grayscale image 402 may be computed. The Laplacian edge map 406 may detect the region of rapid intensity change as edges. Therefore, the Laplacian edge map 406 may detect only sharp edges and may fail to detect edges in the blurry region.

As discussed, the canny edge map 404 and the Laplacian edge map 406 may be divided into the plurality of small patches 408 for blur localization. Further, the variance of each patch of the canny edge map 404 and the Laplacian edge map 406 may be computed. In one or more embodiments, the canny edge map 404 and the Laplacian edge map 406 may be binary and may take only 0 and 255 as pixel values. The white pixels may signify the presence of an edge. Therefore, the variance may indicate the proportion of the white pixels in comparison with the black pixels. Further, the variance of each patch of the canny edge Map 404 and the Laplacian edge map 406 may be compared against each other.

The comparison may be done by computing the ratio of the variance of each patch of the Laplacian edge map 406 and an associated patch of the canny edge map 404 may be computed. The ratio of variance may be directly proportional to the degree of sharpness and may range from (0 to 1). In one or more embodiments, each patch of the plurality of patches may be selected as a threshold for the generation of the localization map 210.

FIG. 5 illustrates a sequence flow depicting an operation of the blur estimator 206 of the system 200, in accordance with one or more embodiments of the present disclosure.

The blur estimator 206 may be configured to generate the estimation map 212 by calculating the confidence of the OCR 502 predictions. The blur estimator 206 may receive the high resolution deblurred image 202 as the input and the estimation map 212 as the output.

The blur estimator 206 may quantify the degree of blur by calculating the confidence of OCR 502 predictions. The deblurred image 202 may be passed through OCR 502 to locate and extract the text T(l) present in the deblurred image 202. The language correction model 504 may be used to identify and correct any spelling errors in the text T(l) to obtain the corrected text, CT(l). Further, the words in the text T(l) may be mapped to the words in the corrected text, CT(l).

In one case, each word in T(l) may be compared with its corresponding word in CT(l) using the normalized edit distance (NED) 506. The NED 506 may signify the confidence of the OCR 502 predictions and quantify the degree of blur. The NED 506 may be the minimum when two words exactly match and the maximum when two words differ in every alphabet position. In an exemplary embodiment, an 1-NED is used to quantify the degree of blur wherein the white region indicates a sharp region and vice-versa.

FIG. 6 illustrates a sequence flow depicting an operation of the attention map extractor 216 of the system 200, in accordance with one or more embodiments of the present disclosure.

The attention map extractor 216 may be configured to fuse the localization map 210 and the estimation map 212 to generate the localization and estimation map 220 or the blur attention map. The attention map extractor 216 may detect the presence of blur in the text and non-text regions of the localization map 210. Further, the attention map extractor 216 may estimate the degree of blur present only in a text area in the estimation map 212.

In one or more embodiments, both the localization map 210 and the estimation map 212 may be concatenated and passed through the series of convolutional layers 602a (“convolutional layers” in the claims). At the end, the sigmoid activation function may be used to obtain the blur attention map/the localization and estimation map 220.

FIG. 7 illustrates a sequence flow depicting an operation of the language corrector 208 of the system 200, in accordance with one or more embodiments of the present disclosure.

The language corrector 208 may be configured to perform the language correction in the blurry region. The language corrector 208 may take the high-resolution deblurred image 202 as the input and the corrected text map 214.

The deblurred image 202 may be passed through the OCR 502 which may give the location of each word and also extract the text content. The location information given by the OCR 502 may be used to construct bounding boxes of the words and thereby produce the localization map 210. The localization map 210 may help to differentiate between adjacent words, especially in the blurry region, and avoid any mixing of words during restoration.

The text extracted through the OCR 502 may be then processed through the language correction model 504 which may identify and correct any spelling errors in the text.

The blur localizer 204 also referred to as an edge-based blur localization module may identify the regions of blur in the blurred image 202 where the white pixels indicate the sharp region. Further, the blur-aware text correction may be performed by taking the convex combination of original and language-corrected text content through edge-based blur localization map 702.

Further, blur-aware text correction 704 may include the localization map 210 and text content 706, corrected text content 708. The following equation (1): Blur-aware Text Correction=Blur Localization Map*Text Content+(1−Blur Localization Map)*Corrected Text Content illustrates the method to obtain blur-aware text correction.

The text correction may be done to ensure that language correction model 504 helps only to restore the text in the blurry region without adversely distorting text in the sharp region. Further, the localization map 210 and the language-corrected text 708 may be combined to generate the corrected text map 214.

FIG. 8 illustrates a sequence flow depicting an operation of the text restoration map extractor 218 of the system 200, in accordance with one or more embodiments of the present disclosure.

The restoration map extractor 218 may be configured to generate the restoration map 222 by considering the corrected text map 214. The restoration map extractor 218 may be configured for feature extraction from the corrected text map 214. Further, the corrected text map 214 may be passed through a series of the convolutional layers 602b (“convolution layers” in the claims) and the activation functions to generate the restoration map 222.

FIGS. 9A-9E illustrate different sequence flows depicting operations of the deblur module 224 referred to as the blur attention and text restoration map guided text deblurring of the system 200, in accordance with one or more embodiments of the present disclosure.

Referring to FIG. 9A, the deblur module 224 may be configured to use the localization and estimation map 220 and the text restoration map 220 to guide text deblurring. The deblur module 224 may consider the blurred image 202 and corresponding the localization and estimation map 220 and the text restoration map 222 as the input and generate the deblurred image 226 as the output.

The blurred image 202 may be passed through the series of convolutional layers to extract the task-specific features 906a-906d. The blurred image 202 may provide the colour and font-related information to an encoder 902. The localization and estimation map 220 may provide crucial information related to blur strength and location to the encoder 902. The text restoration map 220 may provide language-related information to a decoder 904 for further optimal text restoration. The details related to optimal text restoration is described in later embodiments in conjunction with FIGS. 9B-9E.

Referring to FIG. 9B, the deblur module 224 may be configured to generate a salient feature map by considering the blurred image 202 and the localization and estimation map 220 as the input. The deblur module 224 may be configured to use the localization and estimation map 220 to guide the text deblurring.

The blurred image 202, in this case, the high-resolution blurred image, may be passed through the series of the convolutional layers to extract a feature map 908. The feature map 908 may include the task-specific features 906a and 906b. The task-specific features 906a and 906b may be then element-wise multiplied with the localization and estimation map 220. The localization and estimation map 220 provides the amount of blur and may help the deblur module 224 to focus on restoring blurred regions without deteriorating the quality of the sharp regions.

Referring to FIG. 9C, the deblur module 224 may be configured to generate task-specific features 906a-906b by considering the blurred image 202 and the corresponding localization and estimation map 220 as the input. The deblur module 224 may be configured to use the localization and estimation map 220 to guide text deblurring.

The blurred image 202 may be passed through a U-shaped network which consists of 4 encoder-decoder levels. The encoder-decoder levels may correspond to different levels of encoding by the encoder 902 and different levels of decoding by the decoder 904. The features at each encoder level may be element-wise multiplied with the localization and estimation map 220. The guidance of the localization and estimation map 220 may help the deblur module 224 to suppress the less useful features and only allow the propagation of more informative ones. Further, skip connection by element-wise addition of features may be used to ensure feature reusability.

Referring to FIG. 9D, the deblur module 224 may be configured to generate refined task-specific features 906c-906d by considering the blurred image 202 and corresponding the text restoration map 222 as the input. The deblur module 224 may be configured to use the text restoration map 222 to guide text deblurring.

The blurred image 202 may be passed through the series of convolutional layers to extract another feature map 910. The another feature map 910 may include the task-specific features 906c and 906d. The task-specific features are then element-wise multiplied with the text restoration map 222. The text restoration map 222 may correct text in the blurry region and may help the deblur module 224 to restore text precisely in blurry regions without deteriorating the quality of the text in sharp regions.

Referring to FIG. 9E, the deblur module 224 may be configured to generate the task-specific features 906c and 906d by considering the blurred image 202 and the corresponding text restoration map 222 as the input. The deblur module 224 may be configured to use the text restoration map 222 to guide text deblurring.

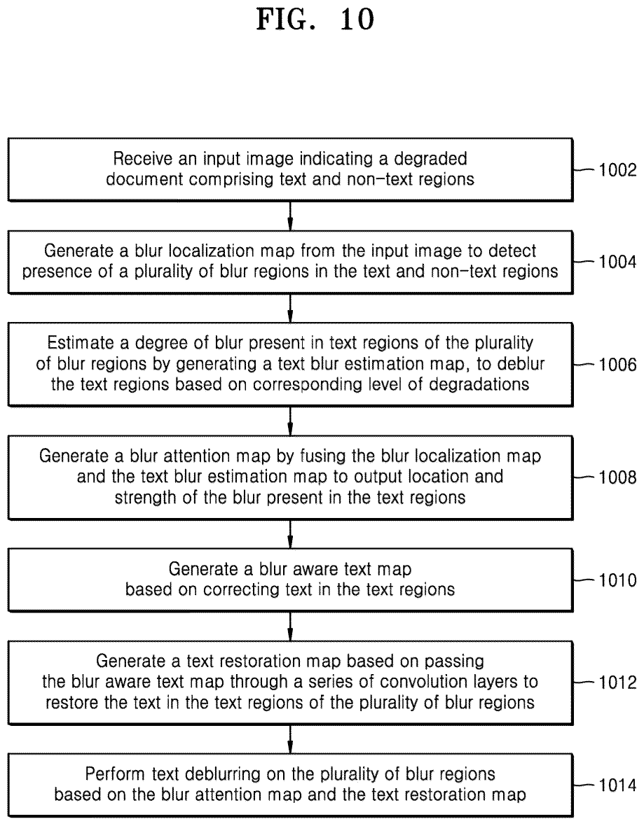

FIG. 10 illustrates a flowchart depicting a method 1000 for correcting the blur in the media, in accordance with one or more embodiments of the present disclosure.

At step 1002, the method 1000 may include receiving the blurred image 202 indicating the degraded document comprising text and non-text regions.

At step 1004, the method 1000 may include generating the localization map 210 from the input image to detect presence of a plurality of blur regions in the text and non-text regions.

At step 1004, the method 1000 may include estimating a degree of blur present in text regions of the plurality of blur regions by generating the estimation map 212, to deblur the text regions based on corresponding level of degradations.

At step 1004, the method 1000 may include generating the localization and estimation map 220 by fusing the localization map 210 and the estimation map 212 to output location and strength of the blur present in the text regions.

At step 1004, the method 1000 may include generating the corrected text map 214 based on correcting text in the text regions.

At step 1004, the method 1000 may include generating the text restoration map 222 based on passing the corrected text map 214 through the series of convolution layers 602b to restore the text in the text regions of the plurality of blur regions.

At step 1004, the method 1000 may include performing text deblurring on the plurality of blur regions based on the localization and estimation map 220 and the text restoration map 222.

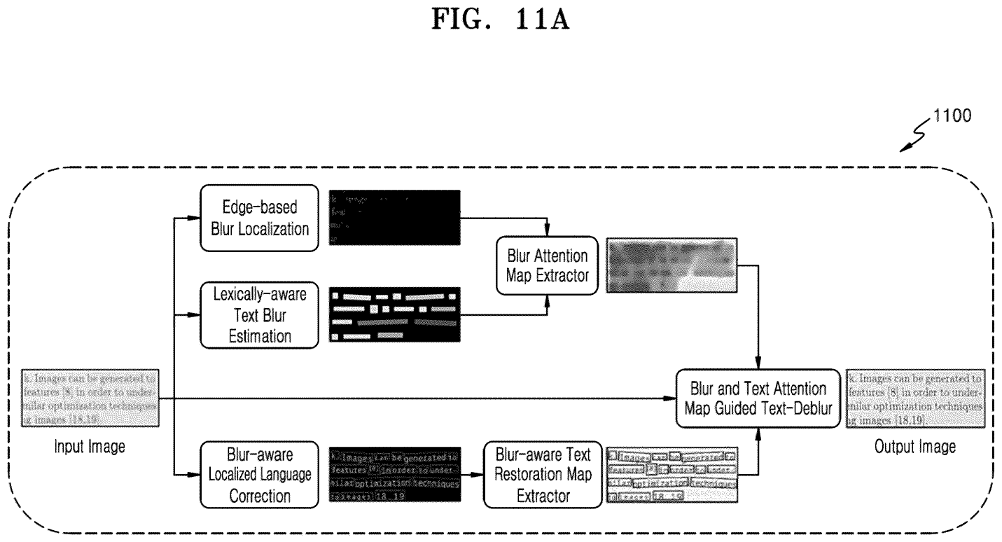

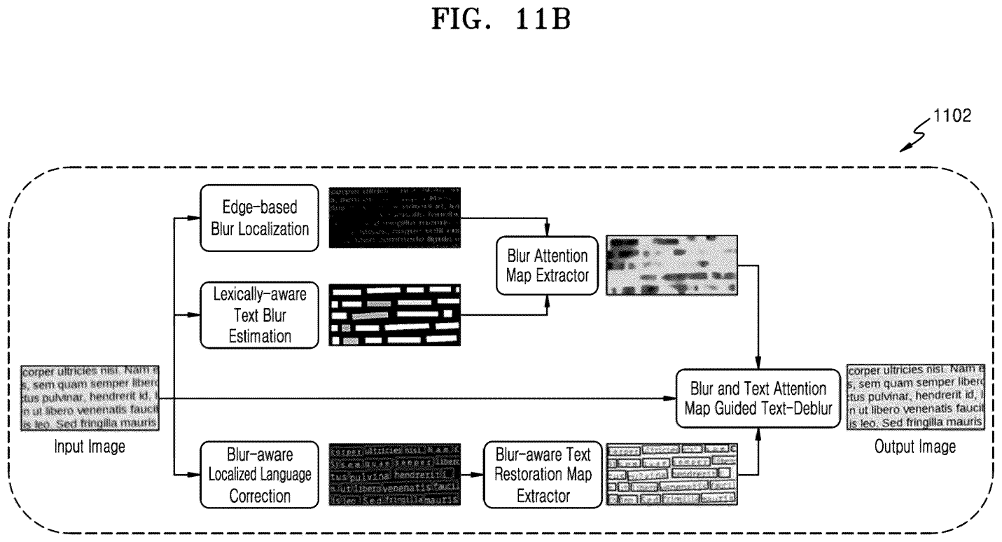

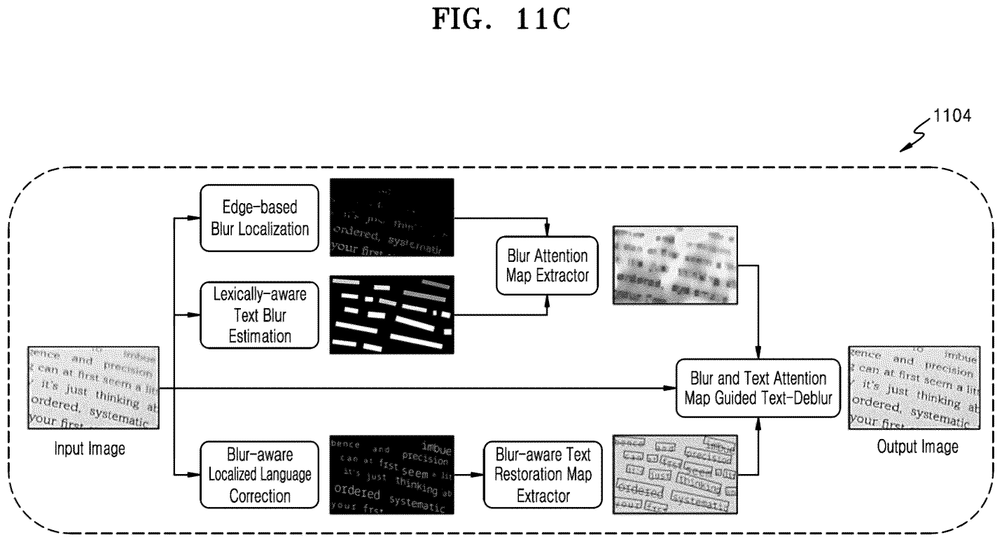

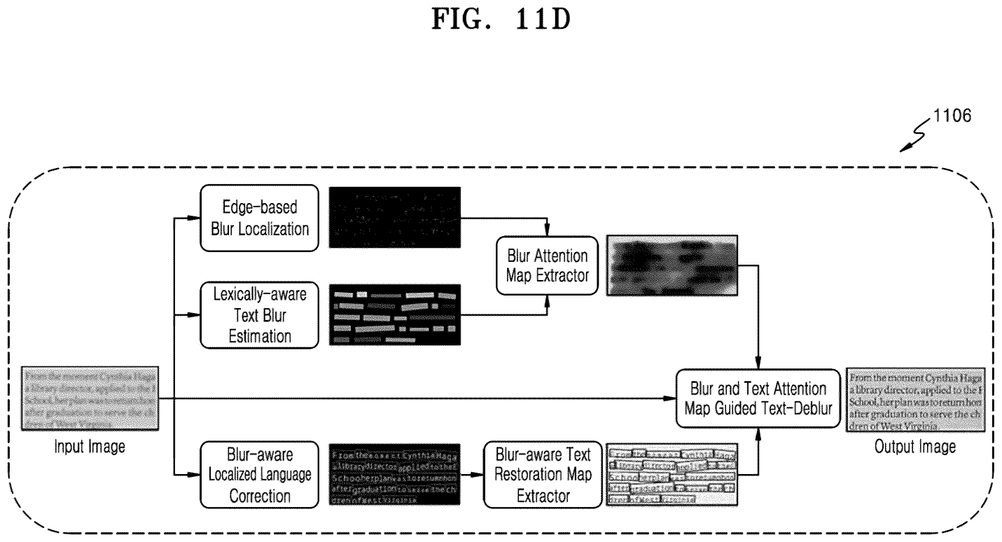

FIGS. 11A-11D illustrate different exemplary scenarios 1100, 1102, 1104, and 1106 of deblurring different media, in accordance with one or more embodiments of the present disclosure.

In one or more exemplary embodiments, as depicted in FIGS. 11A-11D, the blurred image 202 may have a defocus blur, a localized blur, a spatially varying blur, or a global blur. The system 200 as described in conjunction with FIGS. 2-10 may produce the deblurred output image 226 with lexically aware text and linguistically corrected text. In other words, a deblurred image 226 may be generated and output based on deblurred blur regions.

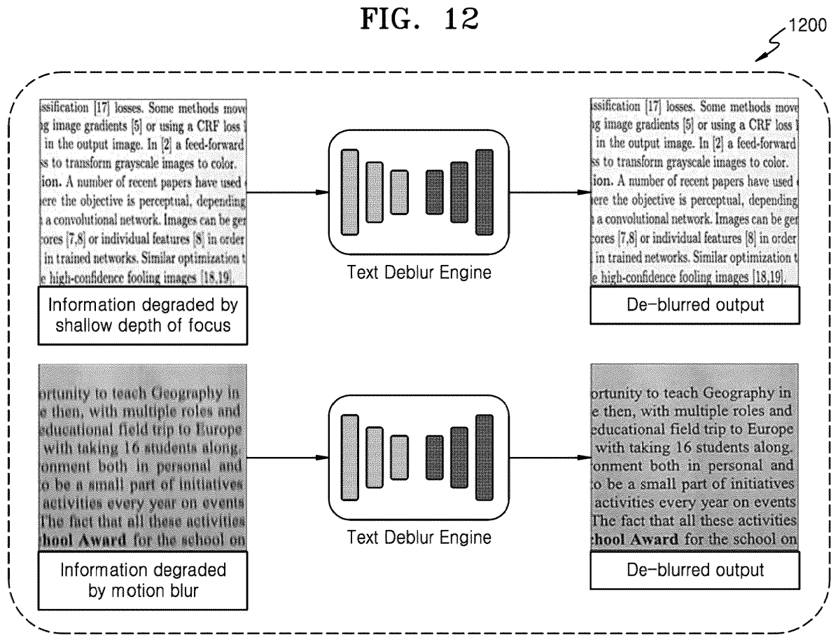

FIG. 12 illustrate another exemplary scenario 1200 of text deblurring in low to mid-tier imaging devices, in accordance with one or more embodiments of the present disclosure.

In an exemplary embodiment, the low to mid-tier consumer-grade smartphones and imaging devices may be susceptible to capturing degraded text in the photos due to the absence of optical image stabilization (OIS) in low-mid-tier devices which often leads to motion blur or shallow depth of focus of lens resulting in de-focus blur.

The system 200 as mentioned in the present disclosure may improve user experience by enhancing the quality of captured textural regions and by leading to cleaner and legitimate documentation of information.

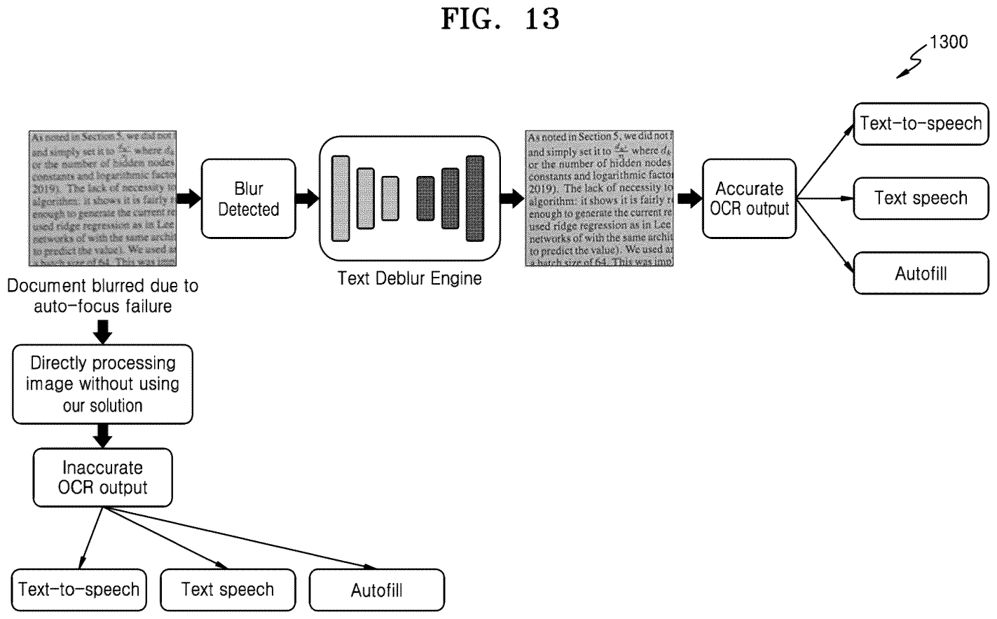

FIG. 13 illustrate another exemplary scenario 1300 depicting optical character recognition (OCR) predictions and associated downstream tasks, in accordance with one or more embodiments of the present disclosure.

In an exemplary embodiment, the images captured using mobile devices are often susceptible to motion blur caused by hand movement and de-focus blur caused by auto-focus failure. The system 200 as mentioned in the present disclosure may provide the OCR detection and hence the downstream tasks like text-to-speech, autofill, text search, etc.

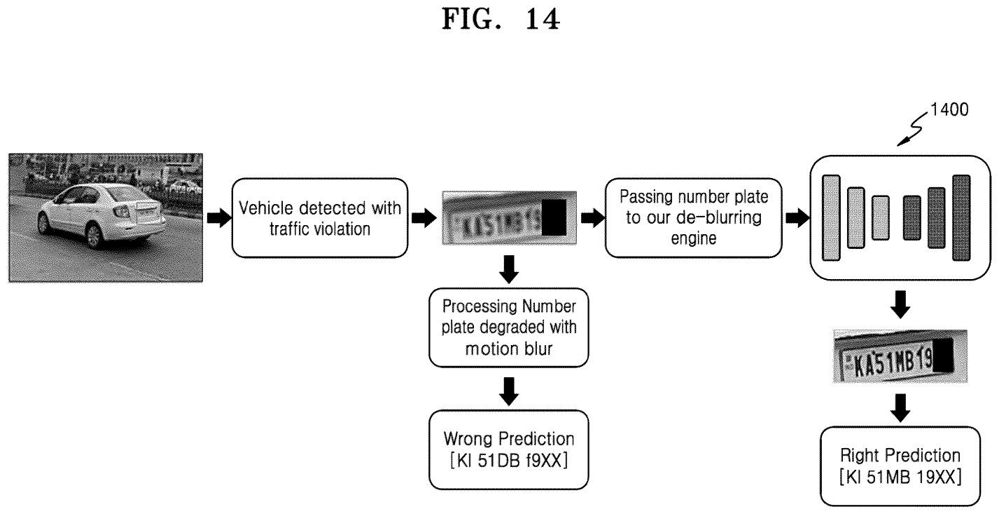

FIG. 14 illustrate another exemplary scenario 1400 depicting number plate recognition in fast-moving vehicles, in accordance with one or more embodiments of the present disclosure.

In an exemplary embodiment, images captured of moving vehicles while traffic violations often are degraded with motion blur. The system 200 as mentioned in the present disclosure may improve the number plate recognition by de-blurring the blurred image.

The present disclosure enhances the quality of scanned documents and improves the readability to a great extent. The present disclosure enables high-quality document scanning feasible in adverse conditions such as scanning without a tripod or with a subtle hand motion, camera in motion, scanning with different camera angles, auto-focus failure, etc.

Although specific units/modules have been illustrated in the figure and described above, it should be understood that the system may include other hardware modules or software modules or combinations as may be required for performing various functions.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Those skilled in the art will appreciate that the operations described herein in the present disclosure may be carried out in other specific ways than those set forth herein without departing from essential characteristics of the disclosure. The above-described embodiments are therefore to be construed in all aspects as illustrative and not restrictive.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for correcting a blur in media, comprising:
receiving an input image indicating a degraded document comprising text regions and non-text regions;
generating a blur localization map from the input image to detect a presence of a plurality of blur regions in the text regions and the non-text regions;
estimating a degree of blur in the text regions of the plurality of blur regions by generating a text blur estimation map, to deblur the text regions based on a corresponding level of degradations;
generating a blur attention map by fusing the blur localization map and the text blur estimation map to output a location and a strength of the blur in the text regions;
generating a blur aware text map based on correcting text in the text regions;
generating a text restoration map based on passing the blur aware text map through a series of convolution layers to restore the text in the text regions of the plurality of blur regions;
performing text deblurring on the plurality of blur regions based on the blur attention map and the text restoration map;
generating a deblurred image based on the deblurred blur regions; and
outputting the generated deblurred image.

2. The method as claimed in claim 1, wherein the generating the blur localization map from the input image comprises:
compressing the input image to a lower resolution and converting the lower resolution input image to a grayscale image;
generating a canny edge map and a Laplacian edge map from the grayscale image to extract structural information and detecting edges of the grayscale image in the plurality of blur regions;
detecting a region of rapid intensity change based on the Laplacian edge map;
dividing the canny edge map and the Laplacian edge map into a plurality of patches for blur localization, wherein the plurality of patches indicate white pixels and black pixels, and a white pixel indicates a presence of an edge;
calculating variances of the plurality of patches of the canny edge map and the Laplacian edge map, wherein the variances indicate a proportion of the white pixels to the black pixels in the plurality of patches;
comparing the variances of the plurality of patches of the Canny edge map with the plurality of patches of the Laplacian edge map, based on computing ratios of variances of the plurality of patches of the Laplacian edge map and the corresponding patches of the canny edge map, wherein the ratios of variances are directly proportional to degrees of sharpness; and
generating the blur localization map based on performing thresholding on the plurality of patches of the canny edge map and the Laplacian edge map.

3. The method as claimed in claim 1, wherein the estimating the degree of the blur in the text regions further comprises:
locating and extracting the text in the input image by passing the input image through an optical character recognition (OCR);
obtaining corrected text by identifying and correcting spelling errors in the text in the input image; and
mapping words in the text in the input image to words in the corrected text, through a normalized edit distance (NED), wherein the NED indicates confidence of the OCR prediction to estimate the degree of the blur.

4. The method as claimed in claim 3, wherein the NED is minimum for a given word when the OCR prediction of the given word and the language corrected output exactly match, and the NED is maximum when the OCR prediction for the given word and the language corrected output differ in every alphabet position.

5. The method as claimed in claim 4, further comprising:
assigning a lexicon confidence score based on a value of the NED to generate the text blur estimation map.

6. The method as claimed in claim 1, wherein the generating the blur attention map further comprises:
detecting the presence of the plurality of blur regions in the text and non-text regions based on the blur localization map;
estimating the degree of blur in the text regions based on the text blur estimation map; and
generating the blur attention map by concatenating the blur localization map and the text blur estimation map by passing through a series of convolutional layers and using a sigmoid activation function.

7. The method as claimed in claim 1, wherein the correcting text in the text regions comprises:
locating and extracting the text in the input image by passing the input image through an optical character recognition (OCR);
constructing bounding boxes of words based on location of the text, to differentiate between adjacent words in the plurality of blur regions;
identifying and correcting spelling errors in the extracted text in the input image through a language correction model;
identifying the plurality of blur regions in the input image based on the blur localization map and performing text correction by taking a convex combination of the text and the corrected text through the blur localization map; and
generating the blur aware text map by combining the blur localization map and the corrected text.

8. The method as claimed in claim 7, wherein the text correction is directly proportional to the blur localization map, text content, and the corrected text.

9. The method as claimed in claim 1, wherein the performing the text deblurring on the plurality of blur regions with the text regions comprises:
extracting task specific features by passing the input image through the series of convolution layers;
extracting color and font related information by passing the input image through an encoder;
estimating the degree of blur in the text regions based on the text blur estimation map; and
performing the text deblurring on the plurality of blur regions based on the text restoration map.

10. The method as claimed in claim 9, further comprising:
restoring the plurality of blur regions by determining the task specific features of the plurality of blur regions based on multiplying elementwise, the task specific features with the blur attention map, without changing quality of sharp regions.

11. The method as claimed in claim 9, further comprising:
generating a feature map indicative of useful features and suppressing less useful features by multiplying the blur attention map to the useful features of levels of the encoder.

12. The method as claimed in claim 9, further comprising:
precisely restoring the text by correcting the text in the plurality of blur regions, by the text restoration map.

13. A system for correcting a blur in media, comprising:
at least one processor; and
memory storing instructions that, when executed by the at least one processor cause the at least one processor to:
receive an input image indicating a degraded document comprising text and non-text regions;
generate a blur localization map from the input image to detect a presence of a plurality of blur regions in the text and non-text regions;
estimate a degree of blur in text regions of the plurality of blur regions by generating a text blur estimation map, to deblur the text regions based on a corresponding level of degradations;
generate a blur attention map by fusing the blur localization map and the text blur estimation map to output a location and a strength of the blur in the text regions;
generate a blur aware text map based on correcting text in the text regions;
generate a text restoration map based on passing the blur aware text map through a series of convolution layers to restore the text in the text regions of the plurality of blur regions;
perform text deblurring on the plurality of blur regions based on the blur attention map and the text restoration map;
generate a deblurred image based on the deblurred blur regions; and
output the generated deblurred image.

14. The system as claimed in claim 13, wherein the instructions further cause the at least one processor, to generate the blur localization map from the input image, to:
compress the input image to a lower resolution and convert the lower resolution input image to a grayscale image;
generate a canny edge map and a Laplacian edge map from the grayscale image to extract structural information and detect edges of the grayscale image in the plurality of blur regions;
detect a region of rapid intensity change based on the Laplacian edge map;
divide the canny edge map and the Laplacian edge map into a plurality of patches for blur localization, wherein the plurality of patches indicate white pixels and black pixels, and a white pixel indicates a presence of an edge;
calculate variances of the plurality of patches of the canny edge map and the Laplacian edge map, wherein the variance indicates a proportion of the white pixels to the black pixels in the plurality of patches;
compare the variances of the plurality of patches of the Canny edge map with the plurality of patches of the Laplacian edge map, based on computing ratios of variances of the plurality of patches of the Laplacian edge map and the corresponding patches of the canny edge map, wherein the ratios of variance are directly proportional to degrees of sharpness; and
generate the blur localization map based on performing thresholding on the plurality of patches of the canny edge map and the Laplacian edge map.

15. The system as claimed in claim 13, wherein the instructions further cause the at least one processor, to estimate the degree of the blur in the text regions, to:
locate and extract the text in the input image by passing the input image through an optical character recognition (OCR);
obtain corrected text by identifying and correcting spelling errors in the text in the input image; and
map words in the text in the input image to words in the corrected text, through a normalized edit distance (NED), wherein the NED indicates confidence of prediction of the OCR to estimate the degree of the blur.

16. The system as claimed in claim 15, wherein the NED is minimum for a given word when the OCR prediction of the given word and the language corrected output exactly match, and the NED is maximum when the OCR prediction for the given word and the language corrected output differ in every alphabet position.

17. The system as claimed in claim 16, wherein the instructions further cause the at least one processor to:
assign a lexicon confidence score based on a value of the NED to generate the text blur estimation map.

18. The system as claimed in claim 13, wherein the instructions further cause the at least one processor, to generate the blur attention map, to:
detect the presence of the plurality of blur regions in the text and non-text regions based on the blur localization map;
estimate the degree of blur in the text regions based on the text blur estimation map; and
generate the blur attention map by concatenating the blur localization map and the text blur estimation map by passing through a series of convolutional layers and using a sigmoid activation function.

19. The system as claimed in claim 13, wherein the instructions further cause the at least one processor, to correct text in the text regions, to:
locate and extract the text in the input image by passing the input image through an optical character recognition (OCR);
construct bounding boxes of words based on location of the text, to differentiate between adjacent words in the plurality of blur regions;
identify and correct spelling errors in the extracted text in the input image through a language correction model;
identify the plurality of blur regions in the input image based on the blur localization map and performing text correction by taking a convex combination of the text and the corrected text through the blur localization map; and
generate the blur aware text map by combining the blur localization map and the corrected text.

20. The system as claimed in claim 19, wherein the text correction is directly proportional to the blur localization map, text content, and the corrected text.
